(19) United States
(12) Patent Application Publication
(10) Pub. No.: US 2026/0064390 A1
(43) Pub. Date: Mar. 5, 2026

(54) CREATING AN APP, SUCH AS CREATING AN APP INCLUDING AN APP USER INTERFACE, METHOD, AND SYSTEM

(71) Applicant: Daniel Morris, Rotterdam (NL)

(72) Inventor: Daniel Morris, Rotterdam (NL)

(21) Appl. No.: 18/820,660

(22) Filed: Aug. 30, 2024

(51) Int. Cl. G06F 8/38; G06F 8/60; G06F 9/451

(52) U.S. Cl. CPC G06F 8/38; G06F 8/60; G06F 9/451

(57) ABSTRACT

For an improved creation of an app, such as an app including an app user interface, a computer-implemented method is suggested including: providing an app development UI of an app development platform to a user for developing the app; receiving image data including at least one digital image and/or structural data; determining at least one set of UI information from the image data using a trained model, wherein the respective set of UI information includes one or more UI elements and/or one or more arrangements of the respective UI element; receiving target app information indicative of at least one target parameter of the app UI via the app development UI; determining at least one match of the respective set of UI information with the respective target parameter; determining the app UI using the respective match; and developing the app using the app UI.

### FIELD

The present disclosure is directed, in general, to software management systems, in particular systems for developing apps, that may be used to manage, build, test, deploy and iterate such apps (collectively referred to here-in as product systems).

### BACKGROUND

Recently, an increasing number of computer software products is used both for personal needs and for business needs in the form of applications, throughout the present patent document simply called “apps”. Such apps may be used in a mobile context as well as on cloud computing platforms and “on premise” and may provide a specific set of functions. The present invention generally relates to the development and the creation of such apps, such as creating an app including developing a user interface of the app.

Currently, there exist product systems and solutions which support managing or developing such apps. Such product systems may benefit from improvements.

### BRIEF SUMMARY AND DESCRIPTION

Variously disclosed embodiments include methods and computer systems that may be used to facilitate creating an app, such as creating an app including an app user interface.

According to a first aspect, a computer-implemented method for creating an app including an app user interface (UI) may include: providing an app development UI of an app development platform to a user for developing the app; receiving image data including at least one digital image and/or structural data; determining at least one set of UI information from the image data using a trained model, wherein the respective set of UI information includes one or more UI elements and/or one or more arrangements of the respective UI element; receiving target app information indicative of at least one target parameter of the app UI via the app development UI; determining at least one match of the respective set of UI information with the respective target parameter; determining the app UI using the respective match; and developing the app using the app UI.

According to a second aspect, a computer system may be arranged and configured to execute the steps of this computer-implemented method according to the first aspect.

According to a third aspect, a computer program product may include computer program code that, when executed by the computer system according to the second aspect, causes the computer system to carry out the method according to the first aspect.

According to a fourth aspect, a computer-readable medium may include the computer program product according to the third aspect. By way of example, the described computer-readable medium may be non-transitory and may further be a software component on a storage device.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the detailed description below, it should be understood that various definitions for certain words and phrases are provided throughout this patent document and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

Embodiments will be described below in greater detail.

### BRIEF DESCRIPTION OF THE DRAWINGS

FIGS. 1 and 2 depict a functional block diagram of example systems that facilitate creating an app, such as creating an app including an app user interface, in a product system, respectively according to an embodiment.

FIGS. 3, 4, 5, and 6 depict a flow diagram of an example methodology that facilitates creating an app, such as creating an app including an app user interface, in a product system, respectively according to an embodiment.

FIG. 7 depicts a block diagram of a data processing system according to an embodiment.

### DETAILED DESCRIPTION

Various technologies that pertain to systems and methods for creating an app, such as creating an app including an app user interface, in a product system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present patent document will be described with reference to exemplary non-limiting embodiments.

An app generally refers to a software program which on execution performs specific desired tasks. In general, several apps are executed in a runtime environment containing one or more operating systems (“OSs”), virtual machines (e.g., supporting Java™ programming language), device drivers, etc.

Apps, including native apps, can be created, edited, and represented using traditional source code. Examples of such traditional source code include C, C++, Java, Flash, Python, Perl, and other script-based methods of representing an app. Developing, creating, and managing such script-based apps, or parts of such script-based apps can be accomplished by manual coding of suitably trained users.

Developers often use Application Development Frameworks (“ADFs”) (which are by themselves applications or apps) for implementing/developing desired apps. An ADF provides a set of pre-defined code/data modules that can be directly/indirectly used in the development of an app. An ADF may also provide tools such as an Integrated Development Environment (“IDE”), code generators, debuggers, etc., which facilitate a developer in coding/implementing the desired logic of the app in a faster/simpler manner.

In general, an ADF simplifies app development by providing reusable components which can be used by app developers to define user interfaces (“UIs”) and app logic by, for example, selecting components to perform desired tasks and defining the appearance, behavior, and interactions of the selected components. Some ADFs are based on a model-view-controller design pattern that promotes loose coupling and easier app development and maintenance.

According to another approach, apps can also be created, edited, and represented using visual model-based representations. Unlike traditional source code implementations, such apps can be created, edited, and/or represented by drawing, moving, connecting, and/or disconnecting visual depictions of logical elements within a visual modeling environment. Visual model-based representations of apps can use symbols, shapes, lines, colors, shades, animations, and/or other visual elements to represent logic, data or memory structures or user interface elements. In order to program a traditional script-based app, programmers are typically required to type out detailed scripts according to a complicated set of programming syntax rules. In contrast, programming a visual model-based app can, in some cases, be done by connecting various logical elements (e.g., action blocks and/or decision blocks) to create a visual flow chart that defines the app's operation. Similarly, defining data structures (e.g., variable types, database objects, or classes) and/or user interface elements (e.g., dropdown boxes, lists, text input boxes) in a visual model-based app can be done by drawing, placing, or connecting visual depictions of logical elements within a virtual workspace, as opposed to typing out detailed commands in a script. Visual-model based apps, including native apps, can therefore be more intuitive to program and/or edit compared to traditional script-based apps. In the present document, an approach is suggested to manage apps, such as to create an app including to develop a user interface of the app, which may involve the explained visual model-based representations.

For brevity, references to a “model,” a “visual model,” or an “application” or “app” should be understood to refer to visual model-based apps, including native apps, unless specifically indicated. In some cases, such visual model-based apps can represent complete, stand-alone apps for execution on a computer system. Visual model-based apps can also represent discrete modules that are configured to perform certain tasks or functions, but which do not represent complete apps-instead, such discrete modules can be inserted into a larger app or combined with other discrete modules to perform more complicated tasks. Examples of such discrete modules can include modules for validating a ZIP code, for receiving information regarding current weather from a weather feed, and/or for rendering graphics.

Visual models may be represented in two forms: an internal representation and one or more associated visual representations. The internal representation may be a file encoded according to a file format used by a modeling environment to capture and define the operation of an app (or part of an app). For example, the internal representation may define what inputs an app can receive, what outputs an app can provide, the algorithms and operations by which the app can arrive at results, what data the app can display, what data the app can store, etc. The internal representation may also be used to instruct an execution environment how to execute the logic of the app during run-time. Internal representations may be stored in the form of non-human-readable code (e.g., binary code). Internal representations may also be stored according to a binary stored JSON (java script object notation) format, and/or an XML format. At run-time, an execution engine may use an internal representation to compile and/or generate executable machine code that, when executed by a processor, causes the processor to implement the functionality of the model.

The internal representation may be associated with one or more visual representations. Visual representations may include visual elements that depict how an app's logic flows, but which are not designed to be compiled or executed. These visual representations may include, for example, flow-charts or decision trees that show a user how the app will operate. The visual models may also visually depict data that is to be received from the user, data that is to be stored, and data that is to be displayed to the user. These visual models may also be interactive, which allows a user to manipulate the model in an intuitive way. For example, visual representations may be configured to display a certain level of detail (e.g., number of branches, number of displayed parameters, granularity of displayed logic) by default. However, users may interact with the visual representation in order to show a desired level of detail—for example, users may display or hide branches of logic, and/or display or hide sets of parameters. Details relating to an element of the visual model may be hidden from view by default but can appear in a sliding window or pop-up that appears on-screen when the user clicks on the appropriate element. Users may also zoom in or out of the model, and/or pan across different parts of the model, to examine different parts of the model. Users may also copy or paste branches of logic from one section of the model into another section, or copy/paste branches of logic from a first model into a second model. In some cases, parts of the model may contain links to other parts of the model, such that if a user clicks on a link, the user will automatically be led to another part of the model. A viewing user may interact with a visual representation in at least some of the same ways that the viewing user might interact with the model if it were displayed within a modeling environment. In other words, the visual representation may be configured to mimic how the model would appear if it were displayed within a visual modeling environment. A single internal representation may correspond to multiple visual representations that use different styles or formatting rules to display app logic. For instance, multiple visual representations corresponding to the same internal representation may differ from one another in their use of color, elements that are included or omitted, and use of symbols, shapes, lines, colors, and/or shades to depict logic flow.

Approaches involving the above-described functionalities of visual model-based representations, visual model-based apps, and/or visual models are sometimes understood to be included by a so-called low-code application development platform or low-code app development platform. By way of example, such a low-code application development platform may further be described as software that provides a development environment used to create application software through graphical user interfaces and configuration instead of traditional hand-coded computer programming. A low-code model may enable developers of varied experience levels to create applications using a visual user interface in combination with model-driven logic. Such low-code application development platforms may produce entirely operational apps or require additional coding for specific situations. Low-code app development platforms may reduce the amount of traditional hand coding, enabling accelerated delivery of business apps. A common benefit is that a wider range of people can contribute to the app's development—not only those with formal programming skills. Low-code app development platforms can also lower the initial cost of setup, training, deployment, and maintenance.

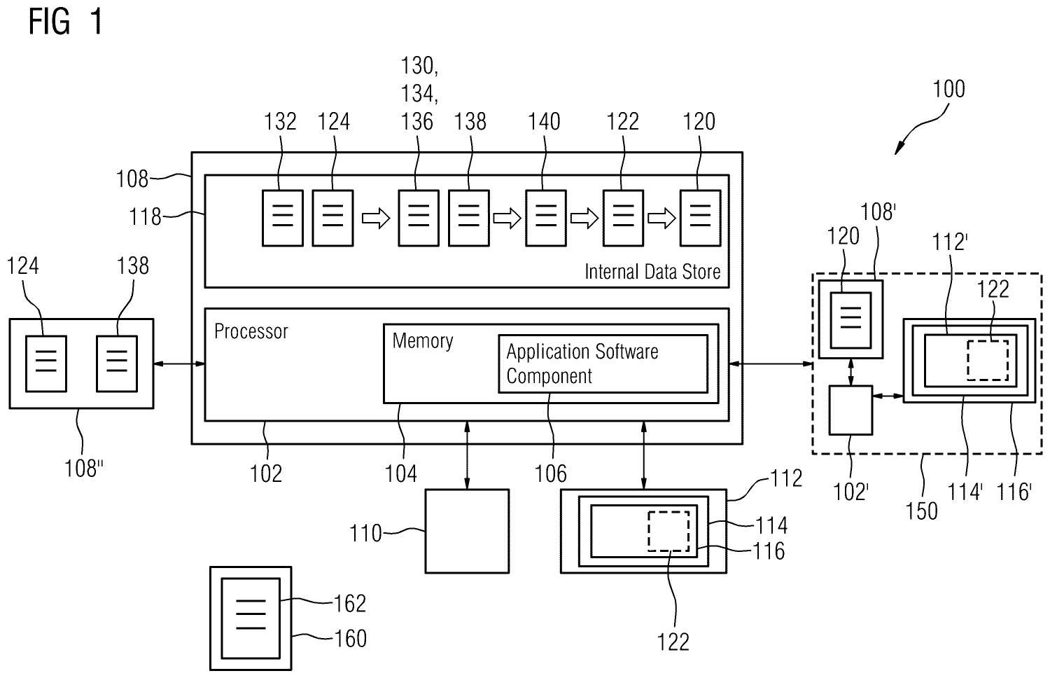

With reference to FIG. 1, a functional block diagram of a first example computer system or data processing system 100 is depicted that facilitates creating an app 120, such as creating an app 120 including an app user interface 122, in a product system 100. The processing system 100 may include an app development platform 118 which may, in some examples, may include at least one processor 102 that is configured to execute at least one application software component 106 from a memory 104 accessed by the processor 102. The application software component 106 may be configured (i.e., programmed) to cause the processor 102 to carry out various acts and functions described herein. For example, the described application software component 106 may include and/or correspond to one or more components of an application for creating an app 120, such as creating an app 120 including an app user interface 122, wherein the application software component 106 may, e.g., be configured to generate and store product data in a data store 108 such as a database.

By way of example, the app development platform 118 may be cloud-based, internet-based and/or be operated by a provider providing support for creating an app 120, such as creating an app 120 including an app user interface 122. In some examples, the user may be located close to the app development platform 118 or remote to the app development platform 118, e.g., anywhere else, e.g., using a mobile device for connecting to the app development platform 118, e.g., via the internet, wherein the mobile device may include an input device 110 and a display device 112. In some examples, the app development platform 118 may be installed and run on a user's device, such as a computer, laptop, pad, on-premises computing facility, or the like.

Examples of product systems that may be adapted to include the app management and/or development, such as for creating an app 120 including an app user interface 122 features described herein may include the low-code software development platform of Mendix Inc., of Boston, Massachusetts, USA. This platform provides tools to build, test, deploy, iterate, develop, create, and manage apps 120 and is based on visual, model-driven software development. However, it should be appreciated that the systems and methods described herein may be used in other product systems (e.g., product lifecycle management (PLM), product data management (PDM), application lifecycle management (ALM) systems) and/or any other type of system that generates and stores product data in a database. Also, examples of databases that may be used as one or more data stores described herein include database server applications such as Oracle, Microsoft SQL Server, or any other type of data store that is operative to store data records.

It should be appreciated that creating an app 120, such as creating an app 120 including an app user interface 122, may be a challenging and time-consuming process which may require highly skilled developers with many years of training and expert domain knowledge. For example, the direct conversion of pixel-level user interface representations into functional code may pose challenges. It may necessitate a profound understanding of web function logic and visual recognition capabilities. Recognizing visual and structural descriptions of the user interface regularly goes beyond simple object detection. Traditional approaches to UI design rely on manual labor and expert domain knowledge. However, this involves multiple iterations of trial and error and quality testing to achieve the desired effect. Hence, an app 120, such as creating an app 120 including an app user interface 122, may be a long and not efficient process. Further, the need of a suitable app 122 may become even more relevant if the app 120 is deployed and operated on a target device 150 to control the target device 150, especially if the app 120, the app UI 122 or the target device 150 is safety critical so that the app 120, the app UI 122 or the target device 150 need to comply with requirements with respect to functional safety.

To enable the enhanced creation of an app 120, such as creating an app 120 including an app user interface 122, the described product system or processing system 100 may include at least one input device 110 and at least one display device 112 (such as a display screen). The described processor 102 may be configured to generate a graphical user interface (GUI) 114 through the display device 112. Such a GUI 114 may include GUI elements such as buttons, links, search boxes, lists, text boxes, images, scroll bars usable by a user to provide inputs through the input device 110 that cause creating an app 120, such as creating an app 120 including an app user interface 122. By way of example, the GUI 114 may include an app development user interface (UI) 116 provided to a user.

In an example embodiment, the application software component 106 and/or the processor 102 may be configured to provide an app development UI 116 of an app development platform 118 to a user for developing the app 120, wherein the app may include an app user interface 122.

As mentioned above, the app development platform 118 may provide or include the above-described functionalities of the development and the creation of the app 120, such as app 120 including an app user interface 122, wherein the app user interface 122 may be the user interface 122 of the app 120. In some examples, the app development platform 118 may support visual model-based representations, visual model-based apps, and/or visual models and, by way of example, may be a visual model-based app development platform or a low-code app development platform. The app development UI 116 may provide an interactive user interface of the app development platform 118 which supports and enables the user to develop the app 120. By way of example, the app 120 may be or include a software program which on execution performs specific desired tasks.

The app 120 to be developed may, e.g., be used by an end user for industrial and/or business purposes. An industrial purpose may, e.g., be to use the developed app 120 for analyzing, monitoring, controlling, and/or managing an industrial field device or plant including several such fields devices, wherein the mentioned devices or plants may correspond to a target device 150 which is explained in more detail below. A business purpose may, for example, be to use the developed app 120 for shopping or retail, e.g., to generate or manage customer orders of a hardware or software product.

In some examples, the app UI 122 may include one or more app UI elements 134 and/or one or more app UI components including several app UI elements 134. Herein, the app UI 122 may be perceived by an app user visually or in a broader sense also audibly or haptically, wherein even olfactory or gustation representations may be included, e.g., linking the respective app UI 122 or app UI element to a sound, to a touch or even to a smell or taste. Further, a multi-modally perceivable representation of the respective app UI 122 or app UI element may, in some examples, be conceivable if more than one sensory modality is concerned, e.g., a visual representation together with an audible representation, e.g., such that the respective app UI 122 or app UI element may be visible and (by activating it) audible to the app end user. In other examples, the haptic representation may involve Braille code, wherein Braille is a tactile writing system used by people who are visually impaired. Herein, the haptic representation may be useful in the context of blind or visually impaired app users, e.g., to communicate information from/to the app end user using a tactile alphabet. In further examples, the haptic representation may be useful in the context of operators of the target device 150 which may, e.g., be a CNC lathe, wherein the haptic aspect of the respective app UI element may be used as a warning to the app end user if the target device 150 might be operated in a critical operation mode. By way of example, the haptic representation may also be used for an alarm or an alarm clock, e.g., if the target device 150 includes or is a smartphone.

By way of example, the application software component 106 and/or the processor 102 may further be configured to receive image data 124 including at least one digital image 126 and/or structural data 144.

In the context of the present patent application, the image data 124 may, e.g., refer to or be included by a respective sample UI 128. Herein, the respective sample UI 128 may, e.g., relate to an existing user interface or, in some examples, to data that is usable to create a user interface, such as the app UI 122. The mentioned data may, e.g., include an image, such as a logo, a screenshot, HTML or CSS data, or, in some examples, corresponding user input, as is explained in more detail below.

The image data 124 of the respective sample UI 128 may, e.g., include a digital image 126 of the respective sample UI 128, wherein a digital image 126 may, e.g., be understood as data of a two-dimensional visual representation, as a drawing, painting, or photograph, or three-dimensional visual representation, such as a carving, a sculpture or in the context of a user interface Braille signs in Braille code. In some examples, the digital image 126 may, e.g., include data of a projection on a surface, activation of electronic signals, or digital displays. In further examples, the respective digital image 126 may include data of images that may be interactive or animated through digital or physical processes so that the digital image 126 may, e.g., include a sequence of data of images, optionally depending on input or interaction of a user. In the context of signal processing, an image may, e.g., include a distributed amplitude of one or more colors. In some examples, the respective digital image 126 may show a user interface of another app or of a device, such as another target device on which the other app may be deployed and operated.

By way of example, the respective digital image 124 of the respective sample UI 128 may include a screenshot, e.g., of an image, such as a logo, or, in some examples, e.g., of the respective sample UI 128.

In some examples, the image data 124 of the respective sample UI 128 may, e.g., include structural data 144 of the respective sample UI 128, wherein structural data 144 may, e.g., be understood as data defining or characterizing the content or structure of the respective sample UI 128. By way of example, the structural data 144 may indicate a number of UI elements in the respective sample UI 128 and optionally the position or arrangement of these UI elements in the respective sample UI 128. In some examples, the structural data 144 may include structural semantics with respect to text included in the respective sample UI 128, wherein the mentioned text may, e.g., be headings, paragraphs, lists, links, quotes, and other items.

By way of example, the structural data 144 of the respective sample UI 128 may include metadata relating to the respective sample UI 128, such as structural metadata, which may, e.g., indicate how compound objects, such as the respective sample UI 128, are put together, for example, how UI elements are ordered and arranged to form the respective sample UI 128. The structural data 144 may, e.g., describe the types, versions, relationships, and other characteristics of the respective sample UI 128 and/or the UI elements included in the respective sample UI 128. The metadata may, e.g., further include descriptive metadata which may be used for discovery and identification. The descriptive metadata may, in some examples, include elements such as title, abstract, author, and keywords, e.g., of the respective sample UI 128 and/or the UI elements included in the respective sample UI 128.

In some examples, the structural data 144 of the respective sample UI 128 may include HTML and/or CSS data relating to the respective sample UI 128, respectively. Herein, Hypertext Markup Language (HTML) is the standard markup language for documents designed to be displayed in a web browser. HTML may define the content and structure of web content. HTML is often assisted by technologies such as Cascading Style Sheets (CSS) and scripting languages such as JavaScript. Web browsers may receive HTML documents from a web server or from local storage and may render the documents into multimedia web pages. Further, HTML may describe the structure of a web page semantically and originally included cues for its appearance. HTML elements are the building blocks of HTML pages. With HTML constructs, images, and other objects such as interactive forms may be embedded into the rendered page. HTML provides a means to create structured documents by denoting structural semantics for text such as headings, paragraphs, lists, links, quotes, and other items. HTML elements are delineated by tags, written using angle brackets. Tags such as <img> and <input> directly introduce content into the page. Other tags such as <p> and </p> surround and provide information about document text and may include sub-element tags. Browsers do not display the HTML tags but use them to interpret the content of the page. In some examples, if the respective sample UI 128 is included in a web page, the corresponding HTML and/or CSS data may provide structural data 144 with respect to the respective sample UI 128.

By way of example, the structural data 144 of the respective sample UI 128 may need to be serialized, e.g., if the structural data 144 includes HTML and/or CSS data. Herein, serialization may be understood to be the process of translating a data structure or object state into a format that can be stored (e.g. files in secondary storage devices, data buffers in primary storage devices) or transmitted (e.g. data streams over computer networks) and reconstructed later (possibly in a different computer environment). When the resulting series of bits is reread according to the serialization format, it can be used to create a semantically identical clone of the original object.

As mentioned above, the respective sample UI 128 may, e.g., relate to an existing user interface or, in some examples, to data that is usable to create a user interface, such as the app UI 122. The mentioned data may, e.g., include HTML or CSS data.

In further examples, the respective sample UI 128 may, e.g., relate to an existing user interface or, in some examples, to data that is usable to create a user interface, such as the app UI 122, wherein the data may be provided as user input by a user of the app development platform 118 or via an application programming interface (API), from another data source 108″ or from the internet. By way of example, the user may provide instructions, e.g., in form of prompts and/or in natural language, to describe at least elements of the sample UI 128 or of the desired app UI 122. E.g., the below mentioned trained model 132 may then use the user input to determine elements of the sample UI 128 or of the desired app UI 122.

In further examples, the respective sample UI 128 may include one or more UI elements 134.

In some examples, the image data 124 may be determined by a user or engineer. The image data 124 may be provided and stored in the data store 108 of the app development platform 118, e.g. by the user using the app development UI 116 and/or the input device 110. In some examples, the image data 124 may be received, e.g., via an application programming interface (API), from another data source 108″ or from the internet.

In some examples, the application software component 106 and/or the processor 102 may further be configured to determine at least one set of UI information 130 from the image data 124 using a trained model 132, wherein the respective set of UI information 130 includes one or more UI elements 134 and/or one or more arrangements 136 of the respective UI element 134.

The image data 124 may be provided as input information to the trained model 132 to derive the respective set of UI information 130 as output data from the image data 124. Herein, the trained model 132 may include an artificial neural network (ANN) which is a model inspired by the structure and function of biological neural networks in animal brains. An ANN may consist of connected units or nodes called artificial neurons, which may loosely model the neurons in the brain. These may be connected by edges, which may model the synapses in the brain. Each artificial neuron may receive signals from connected neurons, may then process them and may send a signal to other connected neurons. The “signal” may be a real number, and the output of each neuron may be computed by some non-linear function of the sum of its inputs, called the activation function. The strength of the signal at each connection may be determined by a weight, which may adjust during the learning process. Herein, neurons may be aggregated into layers. Different layers may perform different transformations on their inputs. Signals may travel from the first layer (the input layer) to the last layer (the output layer), possibly passing through multiple intermediate layers (hidden layers). Herein, a network is typically called a deep neural network if it has at least two hidden layers.

In some examples, the determination of the respective set of UI information 130 from the image data 124 may be done using a trained model 132 which may be rule-based and hence may use rules that result in pre-defined outcomes. Such rule-based, trained models 130 may be defined by ‘if-then’ coding statements (i.e. if X performs Y, then Z is the result), wherein a corresponding set of rules and a set of facts on which the rules rely may be provided beforehand. In some examples, rule-based, trained models 130 may be deterministic, meaning that they operate on a simple yet effective ‘cause and effect’ methodology.

In other examples, the determination of the respective set of UI information 130 from the image data 124 may be done using a generative trained model 132 which may be capable of generating text, images, videos, or other data using generative models, often in response to prompts. Such a generative trained model 132 may, e.g., learn the patterns and structure of their input training data and then generate new data that has similar characteristics.

In further examples, the trained model 132 may combine the above rule-based and generative approaches, e.g., in the form of a rule-based machine learning trained model 132 that may be able to identify and adapt its own set of rules. The defining characteristic such a trained model 132 may be its ability to identify and utilize a set of relational rules that may collectively represent the knowledge captured by the system. It may achieve this, e.g., by utilizing its generative learning algorithm and relying on a knowledge base, meaning it may not require human coding or intervention for defining ‘if-then’ statements.

The respective set of UI information 130 retrieved from the respective image data 124 using the trained model 132 may, in some examples, be considered to be the essence of the respective image data 124 or the respective sample UI 128 which may then be reused to create the app UI 122. Herein, the respective set of UI information 130 may include one or more UI elements 134, e.g., of the sample UI 128, wherein the respective UI element 134 may, by way of example, be or include: an accessibility helper, an accordion, an active filter, an activity indicator, an animation, an area chart, an attribute helper, a badge, a bar chart, a barcode scanner, a date picker, a multi select, a calendar, a cancel button, a carousel, a cell styler, a check-box filter, a checkbox, a color picker, a column chart, a data grid, a data table, a date, a date filter, a date time field, a date calculator, a date picker, a digital clock, a DIV container or an HTML DIV element, a drop down filter, a drop-down, a dynamic image viewer, a dynamic text, a feedback, a file dropper, a file manager, a gallery, an image, an image viewer, an image uploader, an intro screen, a label, a label selector, a layout grid, a light box, a line, a line chart, a list sorter, a list view, a loader, a login, a map, a menu bar, a microflow timer, a multi select drop-down, a navigation list, a navigation tree, a notification, a number filter, a pagination, a paging, a pie chart, a pop-up menu, a progress bar, a progress circle, a pusher listen, a QR code, a radio button, a range slider, a rating, a read only, a rich text, a rich text viewer, a searchable selector, a signature, a simple chart, a simple list, a slide out, a slide out context, a slider, a star rating, a static image, a switch, a tab name, a tab switcher, a table, a tag selector, a template grid, a text box search, a text filter, a text box, a thumb, a time input, a time line, a toggle button, a tooltip, a tree node, a tree view, a tree table, a video player, a web view, or any combination thereof. Further, by way of example, two or more of the mentioned UI elements 134 may be combined to form a respective UI component.

In some examples, the respective set of UI information 130 may further include one or more arrangements 136 of the respective UI element 134, e.g., of the sample UI 128. In the context of user interfaces, the respective arrangement 136 may, by way of example, be understood as the layout of visual elements, here the UI elements 134 on a user interface. E.g., to achieve specific communication objectives, the respective arrangement 136 may, e.g., involve organizational principles of composition, branding style guides or allow for more technical considerations as explained below in the context of functional safety, cyber security, and accessibility. By way of example, the high-level arrangement 136 may involve the overall arrangement of text and images, such as the UI elements 134, wherein, e.g., the position of the respective UI element 134 within the sample UI 128 may be included in the high-level arrangement 136, and optionally the size or shape of the UI elements 134. Further, the high-level arrangement 136 may include information on the overall sample UI 128, such as size and orientation of the sample UI 128. The low-level arrangement 136 may, e.g., include information on boundaries of text areas, bounding boxes, the typeface, and font size, justification preference, e.g., of individual UI elements 134.

By way of example, the respective set of UI information 130 may only include one respective UI element 134. In further examples, the respective set of UI information 130 may include two or more respective UI elements 134 and an arrangement 136 of these two UI elements 134, e.g., indicating that the one two UI elements 134 is to be displayed top or right of the other UI element 134. In some examples, the respective set of UI information 130 may include two or more respective UI elements 134 and an arrangement 136 indicating that the UI elements 134 have text with a predefined font size. In further examples, the respective set of UI information 130 may include two or more respective UI elements 134 and an arrangement 136 of the UI elements 134, e.g., indicating that the respective UI element 134 is animated upon activation, wherein optionally, the UI elements 134 constitute the sequence of the animation.

By way of example, the goal of the determination of the respective set of UI information 130 from the image data 124 using the trained model 132 may be to create a comprehensive dataset that covers a wide range of design possibilities. The dataset may then, e.g., be used to determine a suitable app UI 122 which corresponds to the user's intent or, in some examples, to train the trained model effectively.

By way of example, the application software component 106 and/or the processor 102 may further be configured to receive target app information 138 indicative of at least one target parameter of the app UI 122 via the app development UI 116.

By way of example, the target app information 138 may be provided by the user of the app development platform 118, such as an app developer, to the app development platform 118. In some examples, the user may provide the target app information 138 in natural language, e.g., in written form using a keyboard as the input device 110 and using an input text box of the app development UI 116, wherein oral input may also be possible, e.g. using a microphone as the input device 110. By way of example, if the user provides the target app information 138 in natural language, the app development platform 118 may analyze the provided target app information 138 to derive corresponding target parameters of the desired app UI 122. In further examples, the user of the app development platform 118 may make selections from predefined targets parameters to compose the desired app UI 122, wherein the available target parameters may be displayed to the user via the app development UI 116, and wherein a combination of natural language input and a selection from predefined targets parameters may be possible. Herein, the target app information 138 may, e.g., indicate the app's 120 and optionally the app UI's 122 functionality, purpose, appearance, etc., e.g., according to the user's intent.

By way of example, the user may want to create an app 120 to control a lathe, wherein the app 120 shall be deployed and run on the lathe so that the lathe is the target device 150 of the app 120. In this example, the user may provide corresponding input as target app information 138, wherein the app development platform 118 may extract suitable target parameters of the app UI 122, e.g., indicating that the portion of the app UI 122 shall depict the current operational status of the lathe, available control parameters of the lathe, such as spindle speed, feed rate and cutting depth, available operation statuses, such as automatic, manual, or CNC, and so on.

In some examples, the application software component 106 and/or the processor 102 may further be configured to provide preconfigurable types of the respective target parameter, and to determine the respective target parameter from the target app information 138, e.g. using the trained model 132 and using the preconfigurable types of the respective target parameter. Using the preconfigurable types of the respective target parameter may increase the speed, the quality, and the reliability of the determination of the respective target parameter from the target app information 138 while avoiding errors and mistakes.

In some examples, the target app information 138 may be provided and stored in the data store 108 of the app development platform 118, e.g. by the user using the app development UI 116 and/or the input device 110. In further examples, the target app information 138 may be received, e.g., via an application programming interface (API), from another data source 108″ or from the internet.

In further examples, the application software component 106 and/or the processor 102 may further be configured to determine at least one match 140 of the respective set of UI information 130 with the respective target parameter.

The respective match 140 may, e.g., indicate that a particular set of UI information 130 has sufficiently good agreement or similarity with the respective target parameter of the app UI 122. In some examples, there may be a plurality of sets of UI information 138 which may be available for developing the app UI 122 as intended by the user of the app development platform 118. The user may provide the target app information 138 including one or more target parameters of the desired app UI 122, wherein the respective target parameter may be compared with the available sets of UI information 130 to identify the one or more sets of UI information 130 which best fit to the respective target parameter.

To perform the described matching, by way of examples, the application software component 106 and/or the processor 102 may further be configured to determine a respective similarity value between the respective set of UI information 130 and the respective target parameter, and to determine the respective match 140 among the pairs of the sets of UI information 130 and the target parameters based on the determined similarity values. The respective similarity value may, e.g., be understood as a real-valued function that quantifies the similarity between two objects, here the respective set of UI information 130 and the respective target parameter. In some examples, the similarity may further be understood as the inverse of distance metrics: the similarity values may take on large values for similar objects and either zero or a negative value for very dissimilar objects. Though, in more broad terms, a similarity function may also satisfy metric axioms. By way of example, the cosine similarity may be used as a measure for real-valued vectors for information retrieval to score the similarity of the respective set of UI information 130 and the respective target parameter in a corresponding vector space model.

In some examples, the target app information 138 may include a plurality of target parameters of the app UI 122 so that several matches 140 may be determined, e.g., indicating that several UI elements 134 are to be arranged according to one or more arrangements 136 to build the desired app UI 122.

Herein, the one or more matches 140 may, in some examples, be understood as an attempt to best reflect and fit the provided target app information 138, e.g., using the available set(s) of UI information 130.

By way of example, the application software component 106 and/or the processor 102 may further be configured to determine the app UI 122 using the respective match 140.

The app UI 122 may, e.g., be composed including the determined one or more matches 140. As mentioned above, the target app information 138 may include a plurality of target parameters of the app UI 122 so that several matches 140 may be determined. Accordingly, the app UI 122 may include several UI elements 134 which are arranged according to one or more arrangements 136 according to the determined matches 140. Hence, the application software component 106 and/or the processor 102 may further be configured to compose the app UI 122 using the one or more matching sets of UI information 130. By way of example, the app UI 122 may be a composition of several sets of UI information 130 indicating the use of a respective, particular UI element 134 with a specific size, font, and animated interaction with a user and further indicating where and how the respective, particular UI element 134 is to be arranged in the app UI 122.

By way of example, the app UI 122 may be determined or generated using an algorithm using the determined matches 140 and the matching set(s) of UI information 130. In some examples, the determination of the app UI 122 may use a rule-based algorithm, wherein the algorithm may or may not make use of a trained model, e.g., the above-mentioned trained model 132.

In some examples, the application software component 106 and/or the processor 102 may further be configured to develop the app 120 using the app UI 122.

Using the determined app UI 122, the app 120 may be developed using the app development platform 118. Herein, the app development platform 118 together with the app UI 122 may particularly be suitable to support non-expert users to create and develop their desired app UI 122 and then to develop the app 120 including the app UI 122.

By way of example, the application software component 106 and/or the processor 102 may further be configured to transform the app UI 122 into machine-readable code usable by the app development platform 118 to develop the app 120. In some examples, the format of the machine-readable code may be adapted or specific to the app development platform 118 so that developing the app with the app development platform 118 may be a smooth and efficient process. In further examples, a different format of the machine-readable code may be chosen by the user of the app development platform 118. By way of example, the format of the machine-readable code may be indicated by the user as target app information 138 which may include a corresponding target parameter indicating the desired format of the machine-readable code.

In further examples, the application software component 106 and/or the processor 102 may execute the above-described activities in a different sequence than described above.

In further examples, the app development platform 118 may further provide one or more additional functionalities and support to the user to develop the app UI 122 and the app 120, e.g., to provide meaningful target app information 138. In some examples, these additional functionalities may support design, requirements definition, ideation, evaluation, development, testing to deployment (and even maintenance) of the app UI 122 and/or the app 120. One or more of the earlier steps may be supported by the app development platform 118 by providing a collaborative environment in which several users or stakeholders may drop their input of target app information 138 (e.g., with respect to design, requirements, ideas, evaluation of these aspects). For example, provided ideas for the app UI 122 or the app 120 may be clustered, commented, extended, and rated by the different users or stakeholders using the app development platform 118.

In some examples, the respective additional functionality may be provided to the user via a separate software product, e.g., Adobe Photoshop of Adobe Inc., of San Jose, California, USA, or via a visual editor which is a computer software for editing text files using a textual or graphical user interface that normally renders the content (text) in accordance with embedded markup code, e.g., HTML (Hypertext Markup Language), Wikitext, rather than displaying the raw text. Hence, in some examples, the app development platform 118 may be understood as a software suite or as an application suite which may be a collection of computer programs (such as application software, or programming software) of related functionality, sharing a similar user interface and the ability to easily exchange data with each other. In other examples, the app development platform 118 may be understood as limited to app management or app development only.

In further examples, the respective set of UI information 130 further may include one or more properties of the respective UI element 134, wherein the respective property of the respective UI element 134 may include at least one of a color scheme, a bounding box, a font style, and/or an interactive state of the respective UI element 134.

By way of example, the respective property of the respective UI element 134 may include a visual and/or a functional description of the respective UI element 134. The visual properties of the respective UI element 134 may include a (text) font style, a (text) hierarchy, a (text) line height, a (text) line length, e.g., of text included in the respective UI element 134. The visual properties of the respective UI element 134 may, e.g., further include a color scheme, e.g., using a different color for inactive UI elements 134 (e.g., grey) than for active UI elements 134 (e.g., colorful). Further, information on a bounding box may be included in the visual properties of the respective UI element 134. Herein, a bounding box may, e.g., be understood as rectangular border of or around a UI element 130, e.g., a heading, paragraph, or image, that appears during the design process. These boxes usually have contact points at every corner and in the center of each side to let designers manipulate elements' sizes and shapes more precisely. In some examples, the bounding boxes may overlap or interact as their size and shape is changed, depending on the type of the UI element 134. If UI elements 134 are manipulated that can't overlap, increasing the width of one box might push the box next to it down or to the side to make space.

In further examples, the respective property of the respective UI element 134 may include information on, e.g., at least a visual appearance, a layout, a position, a size, a theme, a style, a styling, a font style, a color palette, a spacing, a border style, an iconography, a button design, an image effect, an animation, a motion, a design, a layout, an input element style, or any combination thereof, with respect to the respective UI element 134. By way of example, the language used in the respective UI element 134 may be considered to be included in the visual representation of the respective UI element 134.

The functional properties of the respective UI element 134 may, in some examples, include information on workflows or activities which may, e.g., be triggered if the respective UI element 134 is activated or deactivated by the end user of the deployed and operated app 120. In further examples, the mentioned workflows or activities may be triggered by data which is provided to the deployed and operated app 120, such as an alarm message generated or received by the target device 150, wherein the alarm message may be communicated to the app user via the app 120 and the app UI 122 or the alarm message triggers further workflows or activities through the app 120. The functional properties of the respective UI element 134 may, e.g., further include information on an animation of the respective UI element 134 relating to an interactive state of the respective UI element 134, wherein the animation may, e.g., be triggered by the user or by data which is provided to the deployed and operated app 120 as described above.

In some examples, the trained model 132 may include a computer vision algorithm 132′, wherein the application software component 106 and/or the processor 102 may further be configured to determine the respective UI element 134 and the respective arrangement 136 of the UI respective element 134 from the respective digital image 126 using the computer vision algorithm 132′.

In some examples, the computer vision algorithm 132′ may acquire, process, analyze and understand digital images 126, and extract high-dimensional data from the real world in order to produce numerical or symbolic information, e.g., in the forms of decisions. In the present context, the computer vision algorithm 132′ may analyze the respective digital image 126, e.g., to extract the respective UI element 134 and the respective arrangement 136 of the respective UI element 134 from the respective digital image 126. Leveraging the computer vision algorithm 132′ to extract the respective UI element 134 and the respective arrangement 136 of the UI respective element 134 from the respective digital image 126 may, e.g., speed up the step of determining the respective set of UI information 130 while allowing for a high quality of this determination step. In some examples, the mentioned computer vision algorithm 132′ may be trained before applying it to the respective digital image 126. The computer vision algorithm 132′ may, e.g., be provided in the data store 108.

A large variety of such computer vision algorithms 132′ are available for various purposes, e.g., including optical character recognition (OCR). Examples of such computer vision algorithms 132′ may include OpenCV (Open Source Computer Vision Library) which is a library of programming functions mainly used for real-time computer vision, machine learning, and image processing. Further, computer vision algorithms 132′ may include object detection algorithms which may be used to detect objects in images or videos. Examples of object detection algorithms include YOLO, SSD, and RetinaNet. In some examples, computer vision algorithms 132′ include feature detection algorithms which may be used to detect features in images, such as edges, corners, and blobs. Examples of feature detection algorithms 132′ include Harris corner detection, SIFT (Scale-Invariant Feature Transform), SURF (Speeded Up Robust Features). Further, the histogram of oriented gradients (HOG) is a feature descriptor which may be used in computer vision for object detection. Also, GPT-4, a multimodal language model, may process both text and image inputs and may, in some examples be used as the trained model 132, as the computer vision algorithm 132′, and/or the large language model 132″ mentioned below. GPT-4 can analyze the contents of an image and connect that information with a written question, and it can extract relevant information from images to provide structured answers. GPT-4 may also recognize certain individuals in images. Although GPT-4 may not strictly be considered to be a computer vision model and does not inherently process images like a computer vision model, it can, e.g., be used in conjunction with computer vision models to extract relevant information that GPT-4 or the computer vision algorithm 132′ can then provide it with its responses.

In some examples, the computer vision algorithm 132′ may include an image encoder. Such an image encoder may, e.g., be used in an auto-encoder which is a sequential neural network that consists of two components: an encoder followed by a decoder. The task of the encoder may be to extract features from the image, thereby reducing the image in height and width but simultaneously growing it in depth. Hence, the encoder may make a latent representation for the image. In the present context, the image encoder may determine the respective UI element 134 and the respective arrangement 136 of the UI respective element from the respective digital image 126. Optionally, a decoder may then decode the latent representation and form an image that satisfies predefined criteria.

In further examples, a cascaded approach may be applied in that the computer vision algorithm 132′ is applied several times, e.g., to sequentially extract different types of UI elements 134 or different types of properties of the respective UI element 134. For example, the computer vision algorithm 132′ may be applied a first time to the respective digital image 126 to extract the bounding boxes, a second time to the respective digital image 126 to extract the color schemes, a third time to the respective digital image 126 to extract the font style, etc., of the respective UI element 134.

By way of example, the structural data 144 may include one or more color schemes, font styles, bounding boxes, and/or interactive states.

In some examples, the structural data 144 may include similar information than the above-mentioned respective property of the respective UI element 134: Hence, the structural data 144 may include a visual and/or a functional description of the respective sample UI 128. The visual aspects included in the structural data 144 may include a (text) font style, a (text) hierarchy, a (text) line height, and a (text) line length, e.g., of text included in the respective sample UI 128. The visual aspects included in the structural data 144 may, e.g., further include a color scheme, e.g., using a different color for inactive UI elements 134 than for active UI elements 134 of the sample UI 128. Further, information on a bounding box included in the respective sample UI 128 may be included in the visual aspects included in the structural data 144.

In further examples, the structural data 144 may include information on, e.g., at least a visual appearance, a layout, a position, a size, a theme, a style, a styling, a font style, a color palette, a spacing, a border style, an iconography, a button design, an image effect, an animation, a motion, a design, a layout, an input element style, or any combination thereof, with respect to the sample UI 128 or, if applicable, with respect to the respective UI element 134 included in the sample UI 128. By way of example, the language used in the respective UI element 134 included in the sample UI 128 may be considered to be included in the visual aspects included in the structural data 144.

The functional aspects included in the structural data 144 may, in some examples, include information on workflows or activities which may, e.g., be triggered if the respective UI element 134 included in the sample UI 128 is activated or deactivated, e.g., by a user of the sample UI 128. In further examples, the mentioned workflows or activities may be triggered by data which is provided to a deployed and operated app including the sample UI 128, such as an alarm message generated or received by a target device 150, wherein the alarm message may be communicated to the app user via the app and the sample UI 128 or the alarm message triggers further workflows or activities through the app. The functional aspects included in the structural data 144 may, e.g., further include information on an animation of the respective UI element 134 included in the sample UI 128 and relating to an interactive state of the respective UI element 134, wherein the animation may, e.g., be triggered by the user or by data which is provided to the deployed and operated app including the sample UI 128 as described above.

In further examples, the trained model 132 may include a large language model 132″, wherein the application software component 106 and/or the processor 102 may further be configured to determine the respective UI element 134 and the respective arrangement 136 of the respective UI element 134 from the digital images 126 and/or structural data 144 using the large language model 132″.

A large language model (LLM) may be understood as a computational model capable of language generation or other natural language processing tasks. As language models, LLMs may acquire these abilities by learning statistical relationships from vast amounts of text during a self-supervised and semi-supervised training process. In some examples, LLMs may use artificial neural networks built with a decoder-only transformer-based architecture, which may enable efficient processing and generation of large-scale text data. These models may, e.g., acquire knowledge about syntax, semantics, and ontologies. The artificial neural networks of LLMs may, e.g., contain a billion to a trillion weights, and are (pre-) trained using self-supervised learning and semi-supervised learning. Some notable LLMs include among others OpenAI's GPT series of models, Google's Gemini, Meta's LLAMA family of models, and IBM's Granite.

In the present context, the digital images 126 and/or structural data 144 may be provided to the large language model 132″ as input data from which the large language model 132″ may extract the respective UI element 134 and the respective arrangement 136 of the respective UI element 134. Leveraging the large language model 132″ to extract the respective UI element 134 and the respective arrangement 136 of the respective UI element 134 from the respective digital image 126 and/or structural data 144 may, e.g., speed up the step of determining the respective set of UI information 130 while allowing for a high quality of this determination step. In further examples, a cascaded approach may be applied in that the large language model 132″ is applied several times, e.g., sequentially to extract different types of UI elements 134, different types of properties of the respective UI element 134, or different types of arrangements 136 of the UI element 134s. For example, large language model 132″ may be applied a first time to the respective digital image 126 to extract the bounding boxes, a second time to the respective digital image 126 to extract the type of arrangement 136, a third time to the respective digital image 126 to extract the font style, etc., of the respective UI element 134. In some examples, the large language model 132″ may be trained before applying it to the respective digital image 126. The large language model 132″ may, e.g., be provided in the data store 108.

By way of example, the image data 124 may include at least one digital image and structural data of at least one sample UI 128, respectively, wherein the trained model 132 is a multi-modal trained model 132 including the computer vision algorithm 132′ and the large language model 132″.

Combining the advantages of the computer vision algorithm 132′ and of the large language model 132″ by using the multi-modal trained model 132 may, in some examples, further speed up the step of determining the respective set of UI information 130 and allow for an excellent quality of this determination step resulting in reliably determined UI elements 134 and arrangements 136 from the digital images 126 and structural data 144. Herein, multi-modal learning may, in the context of machine learning, e.g., be understood as a type of deep learning using multiple modalities of data, such as text, audio, or images. In contrast, unimodal models can process only one type of data, such as text or images. In some examples, multi-modal learning and hence a multi-model trained model 132 may be different from combining unimodal models trained independently as they may combine information from different modalities in order to make better predictions.

In some examples, the application software component 106 and/or the processor 102 may further be configured to provide preconfigurable types of the respective UI information 130, wherein optionally the preconfigurable types depend on a type of the app 120; and to determine the sets of UI information 130 from the image data 124 using the trained model 132 and using the preconfigurable types.

The preconfigurable types of the respective UI information 130 may, e.g., only allow for preconfigured UI elements 134 and/or for preconfigured arrangements 136 of UI elements 134. For example, the preconfigured UI elements 134 and/or preconfigured arrangements 136 may be defined by the user of the app development platform 118 and may be stored in a sort of category library, e.g., in the data store 108. In some examples, when new image data 124 is received, suitable sets of UI information 130 including the preconfigured UI elements 134 and/or preconfigured arrangements 136 may be determined, wherein some remaining aspects of the new image data 124 may not be associated with existing categories, i.e., the preconfigured UI elements 134 and/or for preconfigured arrangements 136. The mentioned, remaining aspects may, in some examples, be discarded and, in other examples, be brought to the attention of the user of the app development platform 118 in order to define additional preconfigured UI elements 134 and/or preconfigured arrangements 136 which may then be added to the category library with the previously already existing preconfigured UI elements 134 and/or preconfigured arrangements 136. Using the described categorization may increase the speed, the quality, and the reliability of the determination of the sets of UI information 130 while avoiding errors and mistakes.

In further examples, the preconfigurable types of the respective UI information 130 may depend on a type of the app 120 or optionally the respective target device 150. The mentioned preconfigurable types may, e.g., reflect the below-mentioned specific requirements to the app 120, the app UI 122, or the target device 150, which may, e.g., relate to functional safety, accessibility, or security requirements the app 120 and/or the target device 150 needs to comply with.

By way of example, the target app information 138 includes at least one of information on functional safety, accessibility, or security requirements the app 120 needs to comply with, information on functional safety, accessibility, or security requirements a target device 150 on which the app 120 is to be deployed and operated needs to comply with, a functionality of the app 120 or the target device 150, a look and feel of the app 120, first user input information 142 on changes to be made to at least one of the digital images 126, or any combination thereof.

The target app information 138 may, e.g., be used to comply with specific requirements to the app 120, the app UI 122, or the target device 150, wherein the specific requirements may, e.g., relate to regulatory requirements, the user's or the user's company's or customer's preferences. The suggested use of the target app information 138 may, by way of example, be a convenient, fast, and reliable way for the user of the app development platform 118 to create the app UI 122 and the app 120 such that the specific requirements are automatically complied with without further user interaction or conscious selection of many options for the app UI 122 or app 120 development by the user.

Herein, functional safety may, e.g., relate to the ASIL, IEC 61508, or ISO 26262 standards and may involve redundancy mechanisms to detect or avoid errors. In some examples, there may need to be a way for the safety-critical UI elements 134 to be loaded and displayed correctly and, depending on the safety policy, upon detecting an error, trigger a restart of the UI, or provide an alternative rendering mechanism to keep the telltales up and running. In some examples, requirements with respect to functional safety of the app 120 or the target device 150 may involve that a certain safety-critical functionality of the app 120 or the target device 150 may not directly be accessible in the app UI 122 or only if the user or administrator of the app 120 confirms activating the safety-critical functionality. By way of example, a safety-critical functionality may be an emergency shutdown of the target device 150, operating the target device 150 outside preconfigurable operating parameters, or operating the target device 150 such that the health or safety of humans might be impaired.

Accessibility may, e.g., relate to recommendations for making content more accessible, primarily for people with disabilities, such as vision disorder including congenital red-green color blindness, myopia, etc. Such recommendations are, e.g., known in the context of web content in the form of the Web Content Accessibility Guidelines (WCAG) published by the Web Accessibility Initiative (WAI) of the World Wide Web Consortium (W3C). Similar accessibility recommendations may apply to the app 120, the app UI 122, and/or the target device 150. In some examples, requirements with respect to accessibility of the app 120 or the target device 150 may involve that certain color combinations or small font sizes of the app UI 122 may not be available, e.g., in the (preconfigurable types of the) respective UI information 130. In such examples, alternative color combinations are larger font sizes in the app UI 122 may be enforced to allow for the required accessibility. In further examples, information such as text may need to be communicated to an app user via the app UI 122, wherein this information may need to be output in haptic representation involving Braille code or audibly via a speaker of the target device 150. In such examples, the target device 150 may include a corresponding UI capable of outputting the information haptically or audibly.

Further, the security requirements may relate to cybersecurity including the protection of computer software, systems and networks from threats that may result in unauthorized information disclosure, theft of or damage to hardware, software, or data, as well as from the disruption or misdirection of the services they provide. In some examples, requirements with respect to security of the app 120 or the target device 150 may involve that no UI elements 134 associated with certain security relevant information, such as passwords, encryption information, the option to install additional software, e.g., malware, on the target device 150, may be available to determine the app UI 122. In further examples, the mentioned security relevant information in the app UI 122 may only be available to an administrator with corresponding permissions so that the administrator may need to confirm via the app UI 122 of the deployed and operated app 120 the administrator's intent to manipulate the mentioned security relevant information.

The functionality of the app 120 or the target device 150 may be indicated by the user in the target app information 138. The indicated functionality may, e.g., involve using the developed app 120 for analyzing, monitoring, controlling, and/or managing an industrial field device or plant including several such fields devices, wherein the mentioned devices or plants may correspond to a target device 150. In such examples, the app development platform 118 may extract suitable target parameters of the app UI 122, e.g., indicating that the portion of the app UI 122 shall depict the current operational status of the target device 150, available control parameters of the target device 150, e.g., a motor speed, or a certain production throughput, available operation statuses, such as automatic, manual, and so on. The suitable target parameters may, e.g., correspond to the above-mentioned preconfigurable types of the respective target parameter.

Herein, the functionality of the respective target device 150 of the app 120 may, in some examples, mean to adapt the target app information 138 and hence the app UI 122 to the available computation, network, display, and/or memory resources of the respective target device 150 on which the app 120 shall eventually be deployed and run. This may, e.g., help to make sure that the app 120 may still be operated or run with tolerable performance on the target device 150. By way of example, if the respective target device 150 is a CNC machine with a low-cost display, no high-res UI elements 134 should be used in the app UI 122 which may be reflected by the corresponding target app information 138. In another example, if the respective target device 150 is a PLC controlling a critical manufacturing process or a train, the app UI 122 should be optimized with respect to performance and availability of the respective target device 150 so that no fancy, high-res, or flickering animations should be used in the app UI 122 which may accordingly be reflected by the corresponding target app information 138.

In some examples, app users or companies providing apps 120 may have a design or style guideline indicating a predefined look and feel of the app 120. Such a look and feel may, e.g., be achieved by using a certain text font, certain colors, emblematic icons for the UI elements 134, or typical arrangements 136 of the UI elements 134. Such requirements may be provided by the user of the app development platform 118 by providing corresponding target app information 138.

By way of example, the user of the app development platform 118 may find that one or more of the digital images 126, e.g., displayed to the user via the app development UI 116, is similar to at least parts of the desired app UI 122, wherein the user may have specific ideas on how to amend the respective digital image 126 to obtain the desired (at least part) of the desired app UI 122. In such examples, the user may provide the first user input information 142 on changes to be made to at least one of the digital images 126. Herein, the first user input information 142 may be included in the corresponding target app information 138 which may then be used for matching of the respective set of UI information 130 with the target parameter corresponding to this target app information 138. In some examples, the first user input information 142 may be provided in natural language, in further examples, the first user input information 142 may be provided in visual or graphic form, e.g., by making corresponding amendments to the respective digital image 126 using graphics editor functionalities provided by the app development platform 118 or some additional graphics editor software, such as Adobe Photoshop of Adobe Inc. of San Jose, California, USA.

In further examples, the application software component 106 and/or the processor 102 may further be configured to displaying the app UI 122 to the user via the app development UI 116, to receive second user input information 142 indicative of an amendment to the respective target parameter of the app UI 122 via the app development UI 116, to determine a respective amended target parameter using the second user input information 142, and to determine the respective match 140 of the respective set of UI information 130 with the respective amended target parameter.

Similarly to the first user input information 142, the user of the app development platform 118 may want to make amendments to the app UI 122 which may be displayed to the user, wherein the app UI 122 may, e.g., be displayed to the user via the app development UI 116. The user may have specific ideas on how to amend the app UI 122 to obtain the desired (at least part) of the desired app UI 122. In such examples, the user may provide the second user input information 142 on changes to be made to the app UI 122. Herein, the second user input information 142 may be used to determine an amended target parameter and optionally, amended target app information 138. The amended target parameter may then be used for matching with the respective set of UI information 130 In some examples, the second user input information 142 may be provided in natural language, in further examples, the second user input information 142 may be provided in visual or graphic form as explained above in the context of the first user input information 142.

In some examples, image data 124 of one sample UI 128 may be received, wherein the received target app information 138 may be indicative of reproducing at least a part of the one sample UI 128.

If the user of the app development platform 118 has identified image data 124 to be reproduced (at least in part), e.g., a digital image 126 of a sample UI 128, the corresponding image data 124 may be provided to the app development platform 118, and the user may provide input in form of the corresponding target app information 138 to express the user' intent of reproducing (at least parts of) the one sample UI 128 for the purposes of creating the desired app UI 122. By way of example, the user may provide the image data 124 in form of the screenshot or photo corresponding to the digital image 126, wherein in further examples, the user may provide metadata, HTML, and/or CSS data indicative of the desired sample UI 128, wherein the provided metadata, HTML and/or CSS data may correspond to the structural data 124. By way of example, if the respective sample UI 128 is included in a web page, the corresponding HTML and/or CSS data may provide structural data 144 with respect to the respective sample UI 128.

In some examples, the received target app information 138 indicative of reproducing (at least parts of) the one sample UI 128 may be used to determine the match 140, wherein the match 140 may, e.g., be understood as an attempt to create the app UI 122 such to best fit and ideally to reproduce the desired (at least parts of the) sample UI 128. In further examples, one or more digital images 126 and/or one or more arrangements 136 included in the desired sample UI 128 may be attempted to be reproduced, e.g., if indicated by the user of the app development platform 118 in the received target app information 138 accordingly.

In further examples, received target app information 138 may be indicative of reproducing only one or more parts of the desired sample app UI 128, e.g., individual UI elements 134 of the sample app UI 128, the look and feel of the sample app UI 128, etc.

By way of example, the application software component 106 and/or the processor 102 may further be configured to train the trained model 132 using at least one of the first user input information 142, the second user input information 142, a determined intersection of union of UI elements 134 included in the app UI 122, or any combination thereof.

In some examples, training the trained model 132 may be beneficial to increase the speed, the quality, and the reliability of the determination of the sets of UI information 130 while avoiding errors and mistakes. The input data to train the trained model 132 may, e.g., include the above-mentioned first or second user input information 142 or other user feedback on the created app UI 122 or the created app 120. In the context of the arrangement 136 of UI elements 134 in the app UI 122, further training input may, e.g., include potential intersection over union of bounding boxes which may, e.g., represent locations or positions of UI elements 134 in the app UI 122. Herein, the intersection over union may be understood as a term to describe the extent of overlap of two boxes, here two bounding boxes. The greater the region of overlap, the greater the intersection over union which may, in some examples, need to be avoided or at least be reduced. Further training input may, e.g., the accuracy of the determined arrangement 136 of the UI elements 134 of the app UI 122 or the accuracy of the above-mentioned classification, wherein the respective accuracy may, e.g., be indicated by the user or by automated tools, e.g., involving machine learning or artificial neural networks. E.g. for the mentioned classification, the trained model 132 may be tasked with predicting a) the most similar target parameters from a predefined set of target app information 138, b) the best matching sets of UI information 130 from a predefined set of target app information 138 or target parameters, and/or c) the best matching sets of UI information 130 from a predefined set of image data 124, wherein the above-mentioned, respective preconfigurable types may optionally be used. In some examples, if the trained model 132 includes two or more trained models, such as one or more of the above-mentioned computer vision algorithms 132′ and/or one or more of the above-mentioned large language models 132″, the mentioned training may be used to identify the best-performing trained model 132. Further, the training may involve human evaluators who may provide preferences among different app UIs which have been generated using different trained models 132.

In further examples, the application software component 106 and/or the processor 102 may further be configured to deploy the app 120 on a target device 150.

In some examples, the respective target device 150 may be physically connected or communicatively connected to another device or connected such, that the respective target device 150 may at least detect input data from the other device, e.g., by optically inspecting the other device. The respective target device 150 and/or the other device may, in some examples, be or include a sensor, an actuator, such as an electric motor, a valve or a robot, an inverter supplying an electric motor, a gear box, a programmable logic controller (PLC), a communication gateway, and/or other parts or components relating to industrial automation products and industrial automation in general. The respective target device 150 may be part of a complex production line or production plant, e.g., a bottle filing machine, conveyor, welding machine, welding robot, etc. In some examples, if the other device belongs to a lower level of the automation pyramid, such as the sensor/actuator or the field level, then the respective target device 150 may belong to a higher level of the automation pyramid, such as field level or the control level.

By way of example, the respective target device 150 may have an internal data store 108′ in which the deployed and operable app 120 may be stored. The respective target device 150 may, by way of example, further include a processor 102′ and a display device 112′. The described processor 102′ may be configured to generate a target device GUI 114′ through the display device 112′, wherein the GUI 114 may include a target device operation UI 116′ provided to a user of the target device 150. The app UI 122 may, e.g., be displayed to the user of the target device 150 via the target device operation UI 116′. In such examples, the target device 150 may include a corresponding UI capable of outputting information of the app 120 and of the app UI 122 haptically or audibly.

Further, the app 120 may be understood as deployed if the activities which are required to make this app 120 available for use by the app end user on the respective target device 150 are completed. The app deployment process may include several interrelated activities with possible transitions between them. These activities may occur at the producer side (e.g., by the app developer) or at the consumer side (by the app user or end user) or both. In some examples, the app deployment process may include at least the release of the app 120 and the installation and the activation of the app 120. The release activity may follow from the completed development process and is sometimes classified as part of the development process rather than deployment process. It may include operations required to prepare a system (here: e.g., the app development platform 118 or an online app store) for assembly and transfer to the computer system(s) (here: e.g., the respective target device 150) on which it will be run in production. Therefore, it may sometimes involve determining the resources required for the system to operate with tolerable performance and planning and/or documenting subsequent activities of the deployment process. For simple systems, the installation of the app 120 may involve establishing some form of command, shortcut, script, or service for executing the software (manually or automatically) of the app 120. For complex systems, it may involve configuration of the system—possibly by asking the end user questions about the intended app use, or directly asking them how they would like it to be configured—and/or making all the required subsystems ready to use. Activation may be the activity of starting up the executable component of software or the app 120 for the first time (which is not to be confused with the common use of the term activation concerning a software license, which is a function of Digital Rights Management systems).

In further examples, the app 120 including the app UI 122 may be deployed and run on the target device 150 and then be used to analyze, monitor, control, and/or operate the target device 150.

It should be appreciated that the described the application software component 106 and/or the processor 102 may carry out an analogous method of creating an app 120, such as creating an app 120 including an app user interface 122. Also, the explained examples may be combined to obtain a more detailed method of creating an app 120, such as creating an app 120 including an app user interface 122. Further, a computer-readable medium 160 which may include a computer program product 162 is shown in FIG. 1, wherein the computer program product 162 may be encoded with executable instructions, that when executed, cause the computer system 100 or and/or the app development platform 118 to carry out the described method.

Among the advantages of the suggested method is that the suggested approach may, e.g., handle open-ended scenarios without depending on trained neural networks on limited data. In terms of performance, using a trained model 132, such as a multimodal trained model 132 or LLM, may, in some examples, provide a more comprehensive and holistic understanding of the UI layout using generic context information that is available to LLMs compared to a dedicated neural network (e.g., Pix2Code) allowing to generate better app UIs 122 and corresponding code. Furthermore, suggested approach may be scalable as it may not require human experts to carry out repetitive developments. The automation provided by the suggested approach may significantly reduce the time and labor cost associated with the manual effort of an app developer.

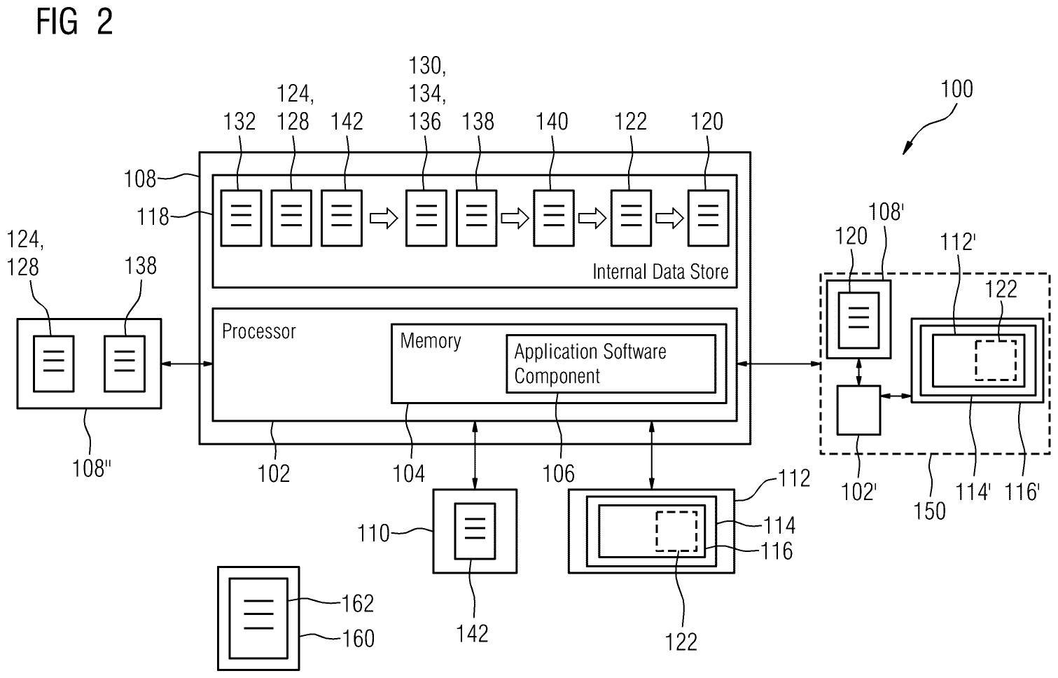

FIG. 2 depicts a functional block diagram of an example system 100 that facilitates creating an app 120, such as creating an app 120 including an app user interface 122, in a product system 100.

The second example system 100 has some similarities to the first example system depicted in FIG. 1. According to the second example system 100, The image data 124 may include one or more digital images 126 and/or structural data 144 of a sample UI 128. Further, the user may provide user input information 142 which may then be used for the determination of the app UI 122. Optionally, the user may provide the first user input information 142 on changes to be made to at least one of the digital images 126, wherein optionally, the respective digital image 126 may be displayed to the user via the app development UI 116. The provided first user input information 142 may then be included in the target app information 138. In further examples, the user may provide second user input information 142 indicative of an amendment to the respective target parameter of the app UI 122 via the app development UI 116, wherein the determined the app UI 122 may be displayed to the user via the app development UI 116. Then a respective amended target parameter may be determined using the second user input information 142 to determine the respective match 140 of the respective set of UI information 130 with the respective amended target parameter.

Further optionally, the user my provide the second user input information 142 indicative of an amendment to the respective target parameter of the app UI 122 via the app development UI 116. Herein, the app UI 122 may be displayed to the user via the app development UI 116, wherein the respective amended target parameter may be determined using the second user input information 142, and wherein the respective match 140 of the respective set of UI information 130 may be determined with the respective amended target parameter.

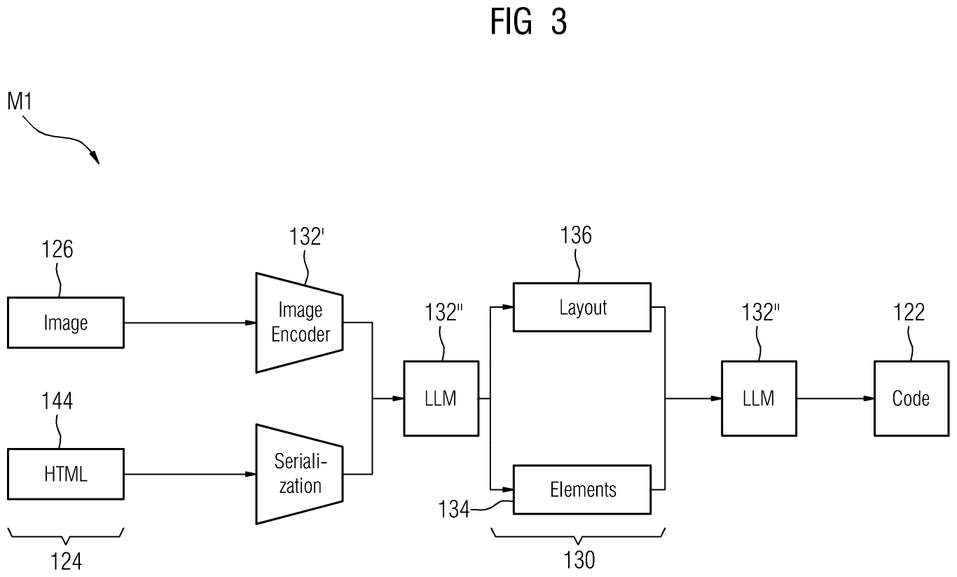

FIG. 3 depicts a flow diagram of a first example methodology M1 that facilitates creating an app 120, such as creating an app 120 including an app user interface 122, in a product system 100.

Image data 124 including one or more digital images 126 and corresponding structural data 144 of at least one sample UI 128, respectively, are provided.

As mentioned above, the image data 124 may, e.g., refer to or be included by a respective sample UI 128. Herein, the respective sample UI 128 may, e.g., relate to an existing user interface or, in some examples, to data that is usable to create a user interface, such as the app UI 122. The mentioned data may, e.g., include an image, such as a logo, a screenshot, HTML or CSS data, or, in some examples, corresponding user input. This understanding may also apply to the other example systems 100 and example methodologies M1 to M4.

The respective digital image 126 may be analyzed using an “Image Encoder” which may be understood to be a computer vision algorithm 132′. The structural data 144 may include HTML data which may be serialized so that the HTML data structure is translated into a more suitable format for further processing, e.g., JSON. The output of both the computer vision algorithm 132′ and the serialization process may then be used as input of the large language model 132″ to determine the respective UI element 134 and the respective arrangement 136 of the respective UI element 134 which may constitute a respective set of UI information 130. Using provided target app information 138 (not shown in FIG. 3) indicative of at least one target parameter and determining a respective match 140 (not shown in FIG. 3) of the respective set of UI information 138 with the respective, corresponding target parameter, the large language model 132″ may determine a respective app UI 122, optionally transformed into machine-readable code, from the respective set of UI information 130.

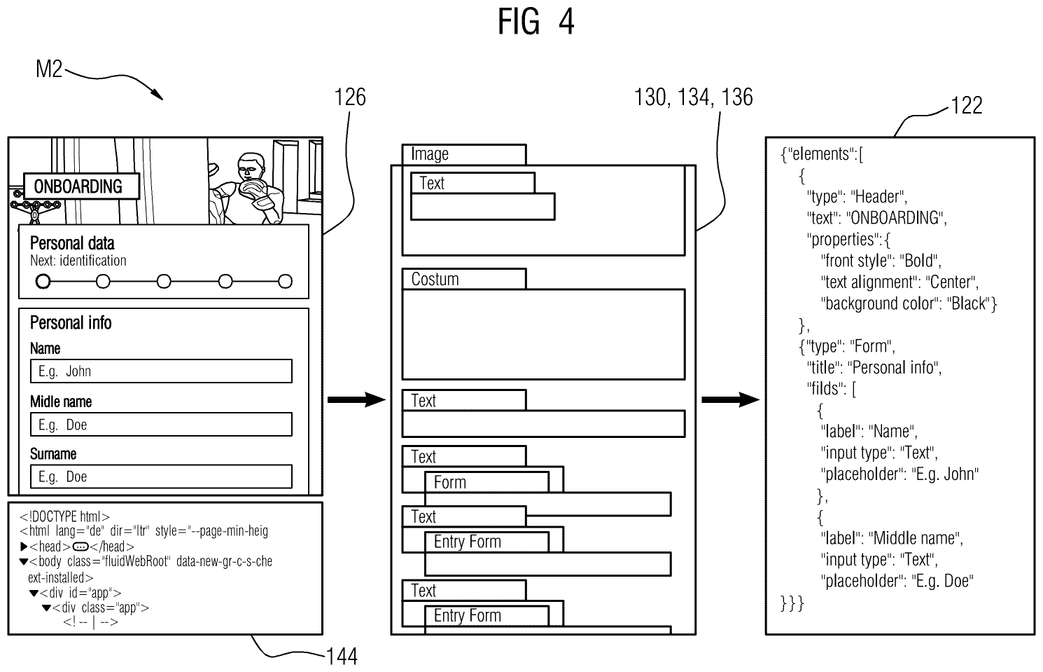

FIG. 4 depicts a flow diagram of a second example methodology M2 that facilitates creating an app 120, such as creating an app 120 including an app user interface 122, in a product system 100.

Image data 124 of a sample UI 128 is provided including a screenshot as a digital image 126 and HTML data as corresponding structured data 144. The image data 124 may, e.g., be available at a web page.

Using a trained model 132 (not shown in FIG. 4), a set of UI information 130 may be determined from the digital image 126 and the structured data 144. As depicted in FIG. 4, several bounding boxes with respective headings (e.g., “Image”, “Text”, “Custom”, etc.) may be determined from the image data 124 as well as several text boxes (the boxes with the “Text” headings). Herein, the bounding boxes may be included in the properties of the respective UI element 134, and the text boxes may be included in the different types of UI elements 134.

By way of example, the user may want to reproduce the sample UI 128 so that corresponding target app information 138 may be indicative of reproducing at least a part of the one sample UI 128. Using this target app information 138 (not shown in FIG. 4), a corresponding match 140 (not shown in FIG. 4) of the set of UI information 138 with the corresponding, respective target parameter may be determined. The match 140 may then be used to determine the app UI 122 of which excerpts of the corresponding code is depicted on the right of FIG. 4.

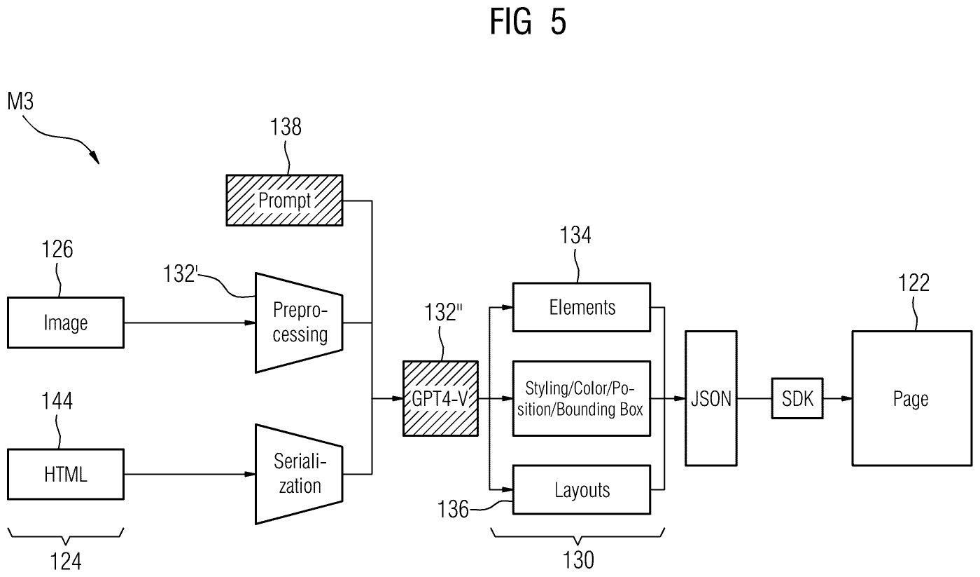

FIG. 5 depicts a flow diagram of a third example methodology M3 that facilitates creating an app 120, such as creating an app 120 including an app user interface 122, in a product system 100.

Similar to the example methodology M1 depicted in FIG. 3 and described above, according to example the methodology M3, image data 124 including one or more digital images 126 and corresponding structural data 144 of at least one sample UI 128, respectively, are provided. The respective digital image 126 may be analyzed using “Preprocessing” which may be understood to be a computer vision algorithm 132′. The structural data 144 may include HTML data which may be serialized so that the HTML data structure is translated into a more suitable format for further processing, e.g., JSON. Further, the user may provide target app information 138 indicative of at least one target parameter of the app UI 122 via the app development UI 116. In further examples, the user may further provide first user input information 142 (not shown in FIG. 5) on changes to be made to at least one of the digital images 126.

The output of both the computer vision algorithm 132′ and the serialization process may then be used as input for the large language model 132″ to determine the respective UI element 134 and the respective arrangement 136 of the respective UI element 134 which may constitute a respective set of UI information 130. The output of the large language model 132″ may, e.g., be available in the JSON format. Using the provided target app information 138 indicative of at least one target parameter and determining a respective match 140 (not shown in FIG. 5) of the respective set of UI information 138 with the respective target parameter, the respective app UI 122 may be determined, e.g., using a software development kit (SDK), e.g., the app development platform 118.

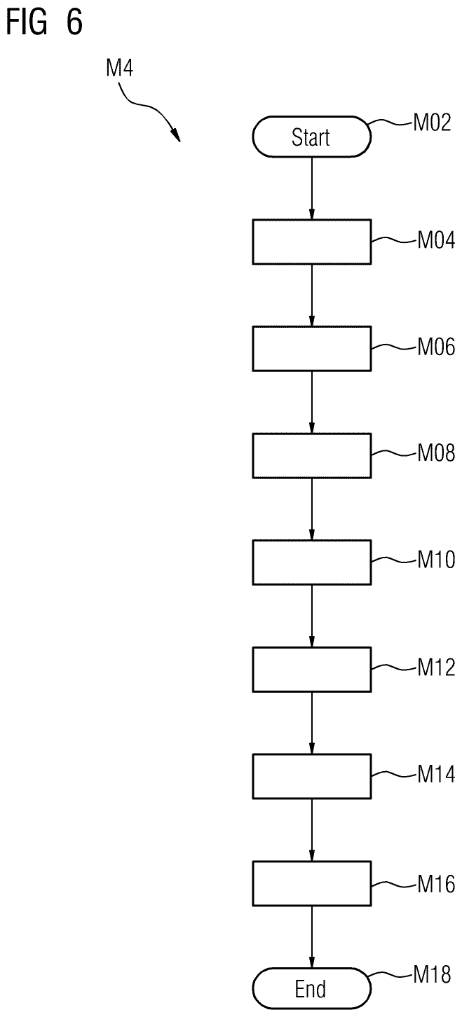

FIG. 6 depicts a flow diagram of a fourth example methodology M4 that facilitates creating an app 120, such as creating an app 120 including an app user interface 122, in a product system 100. The method may start at M02, and the methodology may include several acts carried out through operation of at least one processor.

These acts may include an act M04 of providing an app development UI of an app development platform to a user for developing the app; an act M06 of receiving image data including at least one digital image and/or structural data; an act M08 of determining at least one set of UI information from the image data using a trained model, wherein the respective set of UI information includes one or more UI elements and/or one or more arrangements of the respective UI element; an act M10 of receiving target app information indicative of at least one target parameter of the app UI via the app development UI; an act M12 of determining at least one match of the respective set of UI information with the respective target parameter; an act M14 of determining the app UI using the respective match; and an act M16 of developing the app using the app UI. At M18 the methodology may end.

It should further be appreciated that the methodology M4 may include other acts and features discussed previously with respect to the computer-implemented method of creating an app 120, such as creating an app 120 including an app user interface 122.

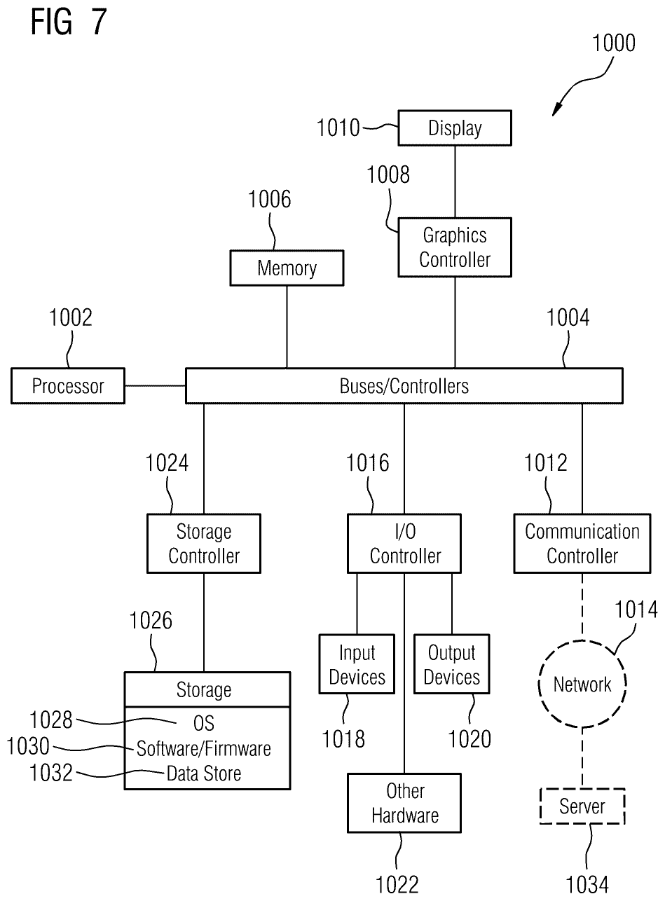

FIG. 7 depicts a block diagram of a data processing system 1000 (also referred to as a computer system) in which an embodiment can be implemented, for example, as a portion of a product system, and/or other system operatively configured by software or otherwise to perform the processes as described herein. The data processing system 1000 may comprise, for example, the computer or IT system or data processing system 100 mentioned above. The data processing system depicted comprises at least one processor 1002 (e.g., a CPU) that may be connected to one or more bridges/controllers/buses 1004 (e.g., a north bridge, a south bridge). One of the buses 1004, for example, may comprise one or more I/O buses such as a PCI Express bus. Also connected to various buses in the depicted example may comprise a main memory 1006 (RAM) and a graphics controller 1008. The graphics controller 1008 may be connected to one or more display devices 1010. It should also be noted that in some embodiments one or more controllers (e.g., graphics, south bridge) may be integrated with the CPU (on the same chip or die). Examples of CPU architectures comprise IA-32, x86-64, and ARM processor architectures.

Other peripherals connected to one or more buses may comprise communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may comprise one or more I/O controllers 1016 such as USB controllers, Bluetooth controllers, and/or dedicated audio controllers (connected to speakers and/or microphones). It should also be appreciated that various peripherals may be connected to the I/O controller(s) (via various ports and connections) comprising input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, it should be appreciated that many devices referred to as input devices or output devices may both provide inputs and receive outputs of communications with the data processing system. For example, the processor 1002 may be integrated into a housing (such as a tablet) that comprises a touch screen that serves as both an input and display device. Further, it should be appreciated that some input devices (such as a laptop) may comprise a plurality of different types of input devices (e.g., touch screen, touch pad, keyboard). Also, it should be appreciated that other peripheral hardware 1022 connected to the I/O controllers 1016 may comprise any type of device, machine, or component that is configured to communicate with a data processing system.

Additional components connected to various busses may comprise one or more storage controllers 1024 (e.g., SATA). A storage controller may be connected to a storage device 1026 such as one or more storage drives and/or any associated removable media, which can be any suitable non-transitory machine usable or machine-readable storage medium. Examples comprise nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may comprise an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may comprise Microsoft Windows, Linux, UNIX, iOS, and Android operating systems. Also, examples of data stores comprise data files, data tables, relational database (e.g., Oracle, Microsoft SQL Server), database servers, or any other structure and/or device that is capable of storing data, which is retrievable by a processor.

The communication controllers 1012 may be connected to the network 1014 (not a part of data processing system 1000), which can be any public or private data processing system network or combination of networks, as known to those of skill in the art, comprising the Internet. Data processing system 1000 can communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system, or part thereof that controls at least one operation, whether such a device is implemented in hardware, firmware, software, or some combination of at least two of the same. It should be noted that the functionality associated with any particular controller may be centralized or distributed, whether locally or remotely.

In addition, it should be appreciated that data processing systems may be implemented as virtual machines in a virtual machine architecture or cloud environment. For example, the processor 1002 and associated components may correspond to a virtual machine executing in a virtual machine environment of one or more servers. Examples of virtual machine architectures comprise VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, it should be noted that the processor described herein may be located in a server that is remote from the display and input devices described herein. In such an example, the described display device and input device may be comprised in a client device that communicates with the server (and/or a virtual machine executing on the server) through a wired or wireless network (which may comprise the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols comprise Teradici's PCOIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, it should be understood that the words or phrases used herein should be construed broadly, unless expressly limited in some examples. For example, the terms “comprise” and “comprise,” as well as derivatives thereof, mean inclusion without limitation. The singular forms

“a”, “an” and “the” are intended to comprise the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to comprise, be comprised within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean: that an element is relatively near to but not in contact with a further element; or that the element is in contact with the further portion, unless the context clearly indicates otherwise.

Although an embodiment of the present disclosure has been described in detail, those skilled in the art will understand that various changes, substitutions, variations, and improvements disclosed herein may be made without departing from the spirit and scope of the disclosure in its broadest form.

None of the description in the present patent document should be read as implying that any particular element, step, act, or function is an essential element, which must be included in the claim scope: the scope of patented subject matter is defined only by the

1. A computer-implemented method of creating an app including an app user interface (UI), the method comprising:
providing an app development UI of an app development platform to a user for developing the app;
receiving image data including at least one digital image and/or structural data;
determining at least one set of UI information from the image data using a trained model, wherein a respective set of UI information includes one or more UI elements and/or one or more arrangements of the respective UI element;
receiving target app information indicative of at least one target parameter of the app UI via the app development UI;
determining at least one match of the at least one set of UI information with the respective target parameter;
determining the app UI using the at least one match; and
developing the app using the app UI.

2. The computer-implemented method of claim 1, wherein the at least one set of UI information further includes one or more properties of the respective UI element, wherein a respective property of the respective UI element includes at least one of a color scheme, a bounding box, a font style, and/or an interactive state of the respective UI element.

3. The computer-implemented method of claim 1, wherein the trained model includes a computer vision algorithm, and wherein the method further comprises:
determining the respective UI element and a respective arrangement of the UI respective element from a respective digital image using the computer vision algorithm.

4. The computer-implemented method of claim 1, wherein the structural data includes one or more color schemes, font styles, bounding boxes, information on an UI arrangement, and/or interactive states.

5. The computer-implemented method of claim 1, wherein the trained model includes a large language model, and wherein the method further comprises:
determining the respective UI element and a respective arrangement of the respective UI element from the respective digital image and/or structural data using the large language model.

6. The computer-implemented method of claim 5, wherein the trained model includes a computer vision algorithm, wherein the method further comprises:
determining the respective UI element and the respective arrangement of the UI respective element from a respective digital image using the computer vision algorithm; and
wherein the image data includes at least one digital image and structural data, respectively, and wherein the trained model is a multi-modal trained model including the computer vision algorithm and the large language model.

7. The computer-implemented method of claim 1, further comprising:
providing preconfigurable types of the respective UI information, wherein optionally the preconfigurable types depend on a type of the app; and
determining the sets of UI information from the image data using the trained model and using the preconfigurable types.

8. The computer-implemented method of claim 1, wherein the target app information includes at least one of information on functional safety, accessibility, or security requirements the app needs to comply with, information on functional safety, accessibility, or security requirements a target device on which the app is to be deployed and operated needs to comply with, a functionality of the app or the target device, a look and feel of the app, first user input information on changes to be made to at least one of the digital images, or any combination thereof.

9. The computer-implemented method of claim 1, further comprising:
displaying the app UI to the user via the app development UI;
receiving second user input indicative of an amendment to the respective target parameter of the app UI via the app development UI;
determining a respective amended target parameter using the second user input; and
determining the at least one match of the at least one set of UI information with the respective amended target parameter.

10. The computer-implemented method of claim 1, further comprising wherein image data of one sample UI is received, and wherein the received target app information is indicative of reproducing a part of the one sample UI.

11. The computer-implemented method of claim 1, further comprising:
training the trained model using at least one of a first user input, a second user input, a determined intersection of union of UI elements included in the app UI, or any combination thereof.

12. The computer-implemented method of claim 1, further comprising:
deploying the app on a target device.

13. A non-transitory computer implemented storage medium that stores machine-readable instructions executable by at least one processor for creating an app including an app user interface (UI), the machine-readable instructions comprising:
providing an app development UI of an app development platform to a user for developing the app;
receiving image data including at least one digital image and/or structural data;
determining at least one set of UI information from the image data using a trained model, wherein a respective set of UI information includes one or more UI elements and/or one or more arrangements of the respective UI element;
receiving target app information indicative of at least one target parameter of the app UI via the app development UI;
determining at least one match of the at least one set of UI information with the respective target parameter;
determining the app UI using the at least one match; and
developing the app using the app UI.

14. A computer system for creating an app including an app user interface (UI), the computer system comprising:
a processor coupled with a memory, the processor configured to provide an app development UI of an app development platform to a user for developing the app, receive image data including at least one digital image and/or structural data, determine at least one set of UI information from the image data using a trained model, wherein a respective set of UI information includes one or more UI elements and/or one or more arrangements of the respective UI element, receive target app information indicative of at least one target parameter of the app UI via the app development UI, determine at least one match of the at least one set of UI information with the respective target parameter, and determine the app UI using the at least one match; wherein the app is developed using the app UI; and
a display configured to display the app UI to the user via the app development UI.
